(19) United States
(12) Patent Application Publication
(10) Pub. No.: US 2017/0091303 A1
(43) Pub. Date: Mar. 30, 2017

(54) Client-Side Web Usage Data Collection

(71) Applicant: Intel Corporation, Santa Clara, CA (US)

(72) Inventors: AL M. RASHID, FOLSOM, CA (US); SUSHU ZHANG, TEMPE, AZ (US); ROBERT H. KUHN, Bezaudun les Alpes (FR)

(21) Appl. No.: 14/863,925

(22) Filed: Sep. 24, 2015

(51) Int. Cl. G06F 17/30; G06N 99/00

(52) U.S. Cl. CPC G06F 17/30598; G06F 17/30887; G06F 17/30604; G06N 99/005

(57) ABSTRACT

In an embodiment, a system includes a processor that includes at least a first core that includes collection logic to record a history of website accesses of a plurality of websites by a user. The first core also includes classification logic to assign the website accesses to corresponding categories by application of a plurality of models, where each model corresponds to a respective category, and to determine a classification summary that includes a plurality of category metrics, each category metric associated with the respective category, each category metric based on a corresponding measure of the website accesses within the respective category. The classification summary suppresses a corresponding identity of each website accessed. The system also includes a nonvolatile memory coupled to the processor. Other embodiments are described and claimed.

### TECHNICAL FIELD

Embodiments pertain to client side web usage data collection.

### BACKGROUND

To design systems competitively, some original equipment manufacturers (OEMs) use data collected on end-user systems. Increasingly, browser usage constitutes a significant part of personal computer usage, and therefore understanding how various types of users use browsers differently may be of importance to understand market segment requirements of personal computers.

Some web services collect raw data on servers including browser cookie tracking, for data-mining on the servers. However, raw browser usage data is private information, and collecting personal computer (PC) users' browsing behavior data in a privacy-preserving and unobtrusive way may be difficult.

Some solutions may be web service-based, requiring raw uniform resource locators (URLs) to be captured between users' requests and websites visited, potentially leaving the user system with a privacy/security risk. Additionally, the web service may log the user's Internet Protocol (IP) address and the URL may even contain personal information such as user name. Further, some solutions are intrusive in that they require a browser plugin or network sniffing.

Many secure browsing web services offer only binary classes, e.g., “child-friendly or not,” “malicious or not,” and are geared toward providing specific services to customers, e.g., parental control. Some solutions work for only broad categorization such as a top level URL domain, e.g., www.youtube.com, which may produce little to no useful information.

### BRIEF DESCRIPTION OF THE DRAWINGS

FIG. 1 is a block diagram of a process, according to embodiments of the present invention.

FIG. 2 is a block diagram of a system, according to an embodiment of the present invention.

FIG. 3 is a flow diagram of a method, according to an embodiment of the present invention.

FIG. 4 is a flow diagram of a method, according to another embodiment of the present invention.

FIG. 5 is a flow diagram of a method according to another embodiment of the present invention.

FIG. 6 is a block diagram of an example system with which embodiments can be used.

### DETAILED DESCRIPTION

In embodiments, if a user opts in, a system can collect the user's browsing history and classify entries into high level system impact categories, e.g., using machine learning techniques. The usage by categories may be sent to a server to represent browser usage of system components. In embodiments, the site names do not leave the client system, to prevent URLs selected by the user from becoming public knowledge.

The following set of guidelines may be used in embodiments:
1. Privacy. Raw URLs do not leave a user's system. Instead, raw URLs are turned into web categories using decentralized classification (also categorization herein) models. Private information does not leak from one site to another, as with cookies.
2. Unobtrusiveness.
   Avoid browser plugins, which may pose a security risk.
   Avoid packet sniffing. In an embodiment, categories may reference computer system function and performance characteristics rather than users' specific actions on the web. For example, multiple forms of online video watching, including even objectionable content, may be mapped to a ‘video streaming’ category. Sites that typically use secure communication may be mapped into a ‘security required’ category, e.g., a shopping site or a bank site. In embodiments, a classifier may transform information about the user into data that pertains to architectural requirements, in order to design more effective systems. The classifier may output an estimated error rate (e.g., confidence level), which can be used in data analysis.

The approach presented herein is capable of classifying a broad range of web site categories by computer system behavior, and may be utilized to determine system component usage for PC designers. Classification may be based on the entire URL, so that most frequently used pages within a domain can be characterized.

Embodiments include machine learning models that can be tuned to any number of categories so as to be appropriate to a privacy sensitivity of each user, addressing common privacy guidelines. For example, specialized user experience studies may make use of machine learning models that correspond to a detailed list of fine-grained categories, e.g., to be applied with users who opt in to a detailed usage collection. On a general usage system, “fuzzier” and smaller number of categories may be used, e.g., resulting in on-client models that may be much smaller and faster. Because cookies are not used in the embodiments presented herein, the models in the embodiments presented would be difficult to be co-opted for unintended purposes, e.g., for information gathering such as specific URLs accessed by a user.

Another benefit of the client side decentralized approach is that the overall computation can be treated as massively parallel, in contrast to a web services-based approach where a number of page hits to the web service from all the clients can be huge, potentially requiring an expensive server infrastructure investment.

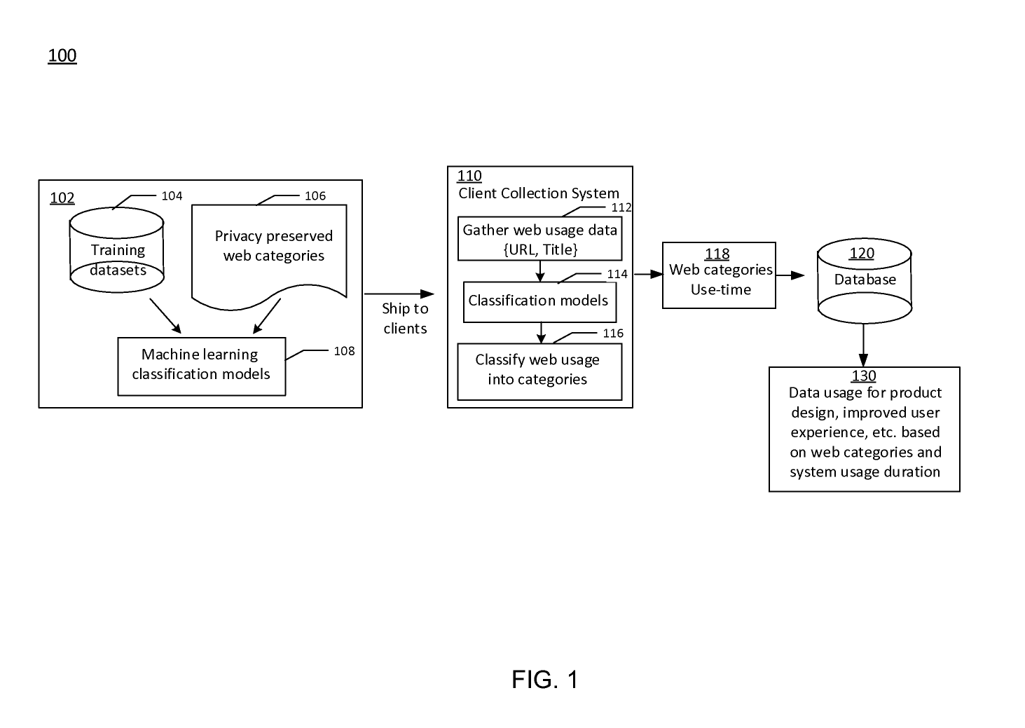

FIG. 1 is a block diagram of a process, according to an embodiment of the present invention. Process 100 includes three phases: model building 102, data collection and classification 110, and server data processing 130.

A first phase 102 is model-building. This is an offline model preparation phase that uses machine learning and text mining. Models generated are able to predict one or more web-categories, given a URL and some page title information.

In an embodiment, phase 102 proceeds as follows:
1. Construct training data. Sample URL data (title, description included) may be gathered from website classification sites, e.g., dmoz.org, parsed, and stored in an analyzable format. Also to be downloaded is data about website popularities, e.g., numerical ranking of URLs according to popularity (e.g., frequency of hits in a defined time period).
2. Determine/prune category names. There are too many (>14,000) categories in a dmoz dataset. However, a typical description in a dmoz dataset may be intended to characterize user usage rather than system usage. As an example, a user may not wish to report the following categories: tobacco (subset of shopping); Minnesota (subset of banking); gambling (subset of games). Instead, more generic categories such as “shopping” and “games” may be preferable (e.g., less revealing of user lifestyle) over “tobacco” and “gambling”.
Categories may be pruned using the following algorithm:
Initially, categories are organized in a hierarchy/tree. Each path through nodes from root to a leaf in this tree forms a category. For example, by calling the root of the tree “top,” the following is a category: top→arts→animation→anime→titles→d→digimon→characters. Each of the “top,” “arts,” “animation,” . . . , “characters” represents a node in the tree. A goal is to eliminate most of these nodes, and treat the set of the remaining leaf nodes as the pruned set.
Consider URLs from dmoz that matches with URL popularity dataset and build a hierarchy of the categories, as present in dmoz. Initially, there are typically >14,000 nodes in the tree, as found in the dmoz dataset. Each node includes two computed statistics. The first statistic is an average weight of the URLs it is associated with the node.
Weight Wᵤ of a URL u may be expressed according to the following:

Wᵤ=−log₂(Rᵤ/2N)
where Rᵤ is the rank of the URL, and N is the total number of popular URLs considered, e.g., N≈10⁶. The most popular URL has Rᵤ=1. The second statistic of each node is how many URLs fall under the node.
The hierarchy tree can be pruned recursively based on the number of URLs covered and average weight (importance/popularity) of the URLs in the sub-tree, until a desired number of categories are left, e.g., 10-50 categories. That is, starting from the root, traversing through a branch, and stops proceeding through that branch if the last node toward the leaf does not have enough average weight or large enough number of URLs. The last node visited on that branch is one of the categories. This iterative process also considers category-filtering, eliminating a set of categories that might be too sensitive to include, e.g., “Adult,” “LGBT,” etc. Finally, review of the categories is conducted and a subset, e.g., 10-30 different categories are selected from the approximately 14,000 categories, to use as a set of categories for classification.
3. Build models. Model building may include preparation of a dataset of {URL, textual description, category} using the selected categories. The dataset is effectively a set of examples from which to learn. Each example has some textual information, e.g., URL and description of the website, and the category. The textual information is tokenized to derive features, which provide hints to the corresponding category. For example, for the URL “linkedin.com,” the description may be: “a networking tool to find connections to recommended job candidates, industry experts and business partners.” One way to tokenize example is to split by words, which gives the following features for this example: linkedin, networking, tool, find, connection, recommend, job, candidate, industry, expert, business, partner. The original category of this URL was “top/computers/internet/on_the_web/online_communities/social_networking,” which after pruning becomes “online_communities.” The tokenized features in each example are treated as (feature) vectors. A total number of features can be huge, and too many features or variables can lead to inferior models. Therefore, the feature space is then reduced using L1 regularization (also known as Lasso Penalty regularization). In L1 regularization, the best model is the one that minimizes prediction error, and has fewer features (variables).
The classification models are then built via linear support vector machine (SVM) or logistic regression with regularization to keep the models generalizable and effective. Typically one model is built for each category. The models may be tested with cross-validation for any improvement required. In cross validation, the available data is randomly split into n-ways, and models are built using (n−1) splits, and the learned model is tested against the remaining split. Each model is to be saved as a corresponding file. Since each model is a linear combination of textual features for a category, each model may include all coefficients (or weights) learned for all of the textual features. For example, in one embodiment in the case or logical regression, the learned model for a category cⱼ may be expressed as

P(Y=cⱼ)=1/(1+e^{-(β}^{₀}^{Σβifi)})
where the learned coefficients βᵢ corresponding to the tokenized textual features, fᵢ, are saved as models. Maximization of distinction between categories (e.g., selection of non-overlapping categories) can enhance utility of the categories.
The models are to be shipped to the client systems along with a collector (e.g., software to perform the data collection).

A second phase 110 includes data collection and classification. A low intensity collector in the client system, e.g. personal computer (PC), gathers web usage data 112 that includes minimal browsing history data (e.g., URLs and page titles) and system utilization, e.g., CPU consumption, by the web sites visited. The history data is then tokenized and passed into a classifier 116 to perform a classification, e.g., determine a corresponding category in which to place each URL. The classifier 116 uses the classification models 114 learned in phase 102 to determine output 118 that includes a quantitative classification of the web site accesses, to be sent to a database 120. The classification suppresses the identity of each website, and instead presents a quantitative measure of website access (e.g., based on website access frequency and website access durations) according to each category.

A third phase 130 is server data processing. Anonymous and de-identified information is uploaded to the server from the database 120, e.g., for analysis. The analysis may be used as system use feedback in analytics that may, e.g., influence product improvement of components, design specifications of hardware or software, etc.

The above-described approach includes a trained/learned information transformation algorithm that produces compression of information with intentional loss of precision, while focusing on de-identifying personal information. Categories can be coarse and privacy-preserving. An algorithm may be invoked to automatically prune thousands of fine-grained categories (e.g., retrieved from dmoz.org) into a smaller number of categories. A further refinement process may be invoked to preserve privacy of categories, e.g., through a filter that provides “sanity checks” constructed according to privacy principles e.g., developed by privacy experts and via user studies. The user studies or surveys can be conducted periodically, e.g., annually, semi-annually, etc., and may be automated. In one embodiment, the final number of categories to be used for classification is between 10 and 100.

In embodiments, classification (e.g., category determination) of URLs happens locally on the user's system, unlike many solutions where the explicit URLs are sent to a web service that potentially exposes the user's IP address and where the web server can store sensitive web usage data server.

In embodiments, a non-intrusive, secure collector is used. The collector is neither a plug-in to the browsers that can make browsers unstable and pose security risks, nor it is a network packet sniffer.

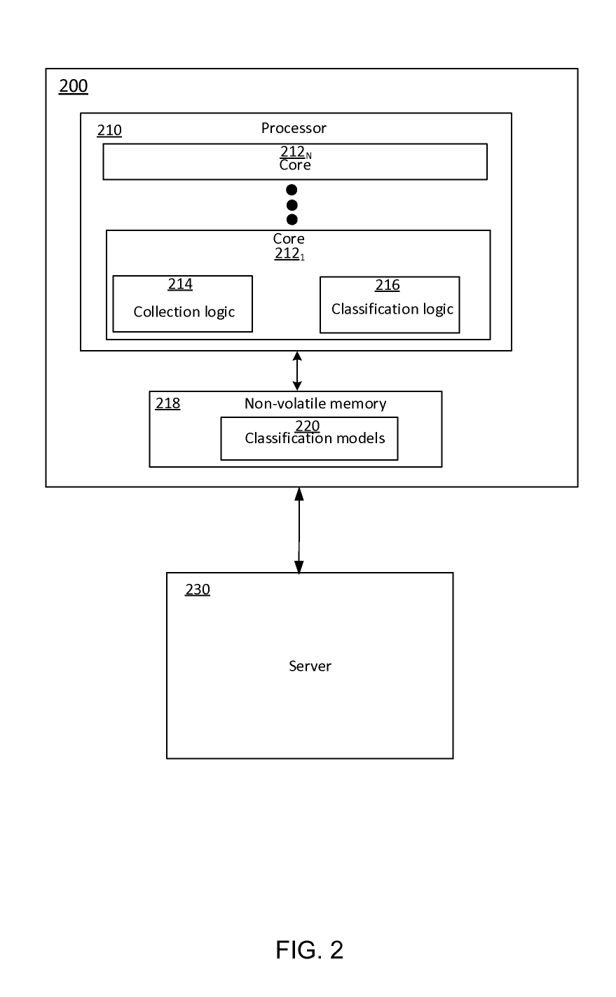

FIG. 2 is a block diagram of a system according to embodiments of the present invention. System 200 is a personal computer that includes a processor 210 and a non-volatile memory 218. The processor 210 includes one or more cores 212₁ to 212_{N}. Core 212₁ may include collection logic 214 and classification logic 216. In embodiments, the nonvolatile memory 218 may store classification models 220, each model corresponding to a category. The system 200 may be coupled to a server 230.

In operation, the collection logic 214 (e.g., hardware, software, firmware, or a combination thereof) may be executed in the core 212₁ and upon execution may collect, during a usage period, a history of URLs (optionally including a title on a corresponding title page of each URL) accessed by a user and corresponding elapsed access times. The collection logic 214 can pass the collected history to the classification logic 216, which can classify the URLs according to the classification models 220 (e.g., developed accorded to model building described above) that are typically stored in the nonvolatile memory 218. For example, each classification model can indicate, based on URL information received, whether the URL in question falls in the category corresponding to the classification model. Generally, categories are constructed to be non-overlapping. Additionally, the categories are constructed so as to suppress detailed personal preference information, e.g., the URL of each website accessed.

A classification report that is output from the classification logic 216 may include a relative importance of each category determined from the URL access history received, e.g. a numerical value associated with the category for the particular access history being analyzed. The complete classification report (also classification summary, or categorization summary herein) for the particular URL access history typically may include a corresponding value for each category based on, e.g., a count of URLs and access time of each URL. The classification report output suppresses (e.g., omits) the identity of each URL in order to protect privacy of the user. The classification report may be output to server 230.

The server 230 may store the classification report. The classification report may be used to determine modification of a future generation of the system 202. For example, the server 230 may collect many classification reports from various users and may analyze the classification reports received to produce an analysis that may point to inferences based on the populations of each of the categories. The analysis may be used as a basis, e.g., in analytics, to implement design changes, e.g., to effect improvement in utility of the system by users.

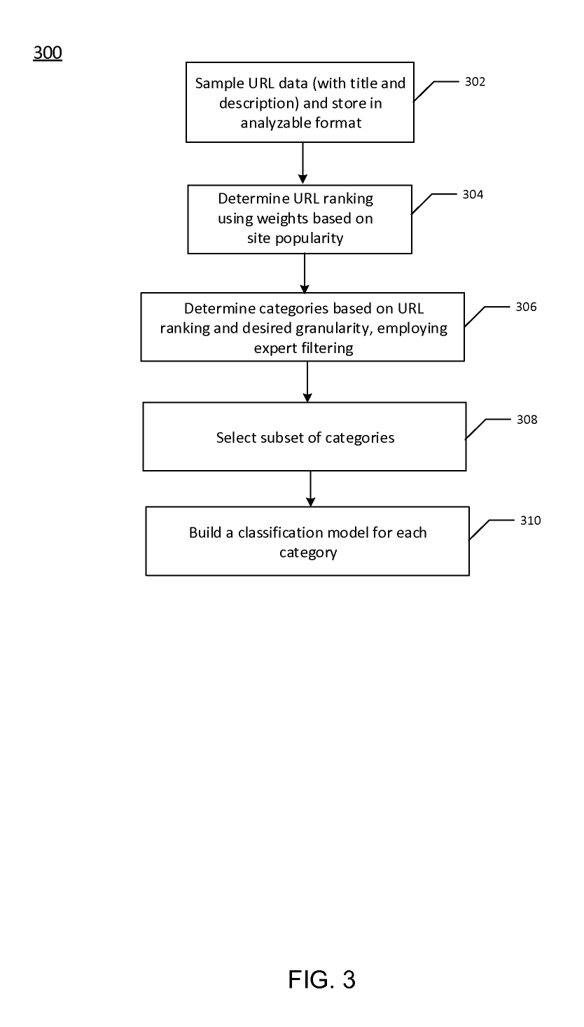

Referring to FIG. 3, shown is a flow diagram of a method according to an embodiment of the present invention. Method 300 is a method of developing classification models. Method 300 begins at block 302, where URL data is sampled and stored in an analyzable format. For example, the URL data may come from a source of URLs such as dmoz.com. Continuing to block 304, a URL ranking for each URL sampled may be determined based on a source of URL popularity rankings, e.g., from www.alexa.com. Advancing to block 306, categories may be determined based on URL rankings and a desired granularity of the categories. The desired granularity (e.g. number of categories) is an input to the algorithm. For example, in embodiments, a count of the categories created will be less than a count of URLs sampled, and the categories selected are intended to preserve privacy by suppressing URL titles and characteristics deemed too personal to be shared. For example, an expert filter (e.g., software, hardware, firmware, or a combination thereof) may be applied to the categories to filter out those categories deemed too personal to be shared (e.g., filtering out categories such as “adult movies”) and instead include more general categories (e.g., “movies”). The filter may be constructed by following common privacy guidelines, and from the outcome of user surveys that may reveal sensitivity to categories.

Moving to block 308, a subset of the determined categories may be selected, depending on the granularity specified. Proceeding to block 310, a classification model may be built for each category using L1 regularization, linear regression, etc. Each model is associated with a corresponding category and can provide a quantitative measure of a fit of a URL to the corresponding particular category. The models may be used to determine in which category to place a URL that is logged, e.g., in a URL access summary of a user.

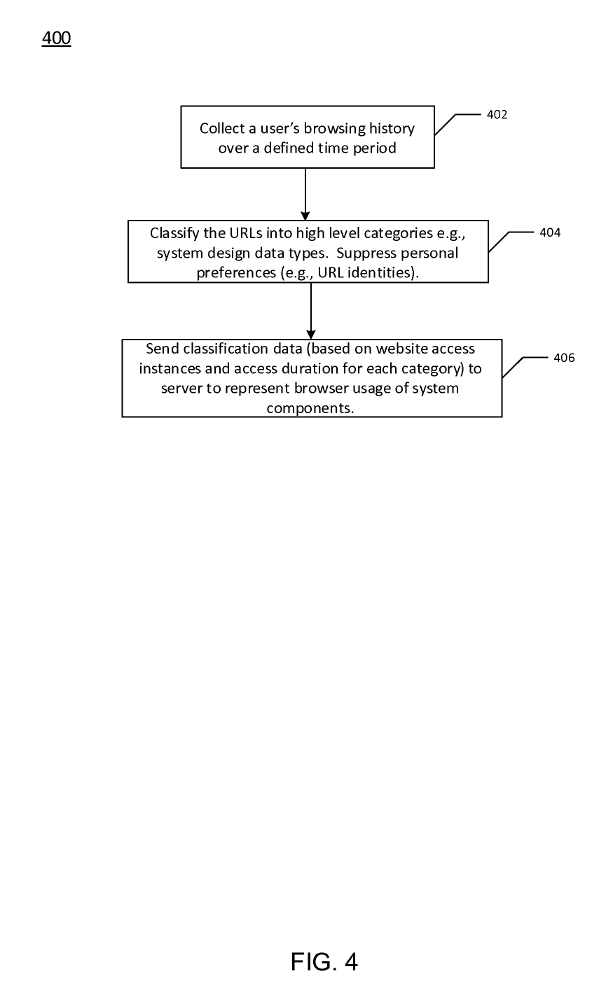

FIG. 4 is a flow diagram of a method according to another embodiment of the present invention. Method 400 begins at block 402, where a user's browsing history (e.g., list of URLs visited and length of time visited) is collected over a defined time period. Continuing to block 404, at the user's device, the URLs are classified into high level categories through use of classification models, the categories suppressing identities of the URLs and associated page titles. Suppression of the URL identities and titles pages is intended to protect privacy of the user. Advancing to block 406, a classification summary (e.g., system usage by category) is sent to a server. The classification summary is a representation of browser usage of a user by category (e.g., based on instances of website access and duration of each access), and may, along with other classification summaries sent from other users' PCs, be analyzed to provide as input for product design and/or modification, e.g., to effect improvement of system components of the user's PC.

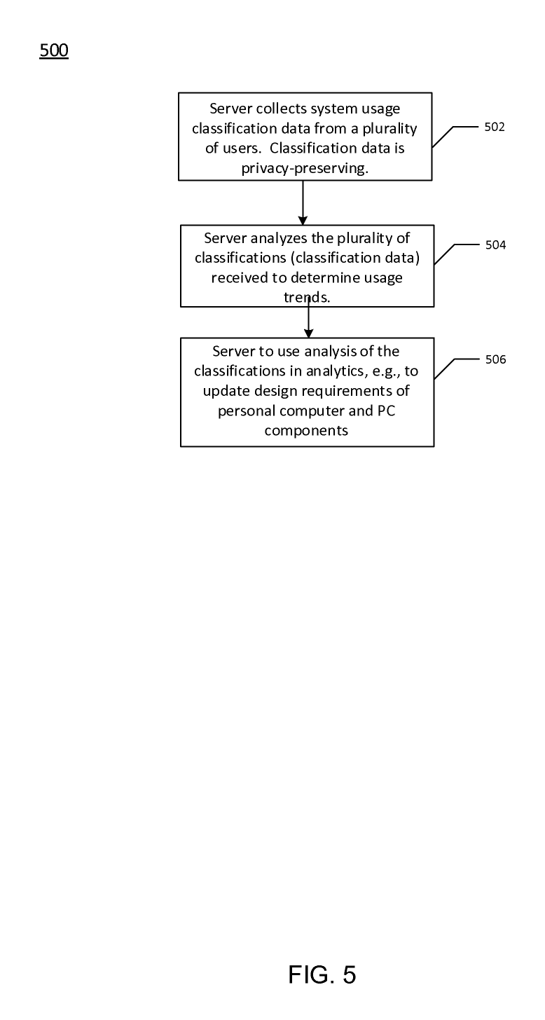

FIG. 5 is a flow diagram of a method according to another embodiment of the present invention. Method 500 begins at block 502, where a server collects system usage classification data from each of a plurality of users (e.g., users that are participants in a usage study) via the user's personal computer. In embodiments, the classification data includes a category population count of websites accessed by a user over a defined time period, and may also include access duration of each access instance. Each accessed website is to be classified within one of a defined set of categories (e.g., non-overlapping) that are privacy-preserving. Privacy preservation is achieved through initial selection of the defined categories. For instance, the categories may be selected so as to suppress an identity (e.g., URL) of the websites to be classified, and categories may be selected so that a classification (e.g., classification data from a user) reflects system usage of the personal computer (PC) of the user, e.g., categories may be determined in part through use of a filter to filter out categories that reveal personal preferences, the filter constructed based on expert input.

Continuing to block 504, the server analyzes the plurality of classifications received from the various PCs to determine system usage trends among the participants of the study. Advancing to block 506, the server can use the analysis of the classifications in analytics that can, e.g., provide input to update design requirements of PCs and PC components, improve user experience, etc.

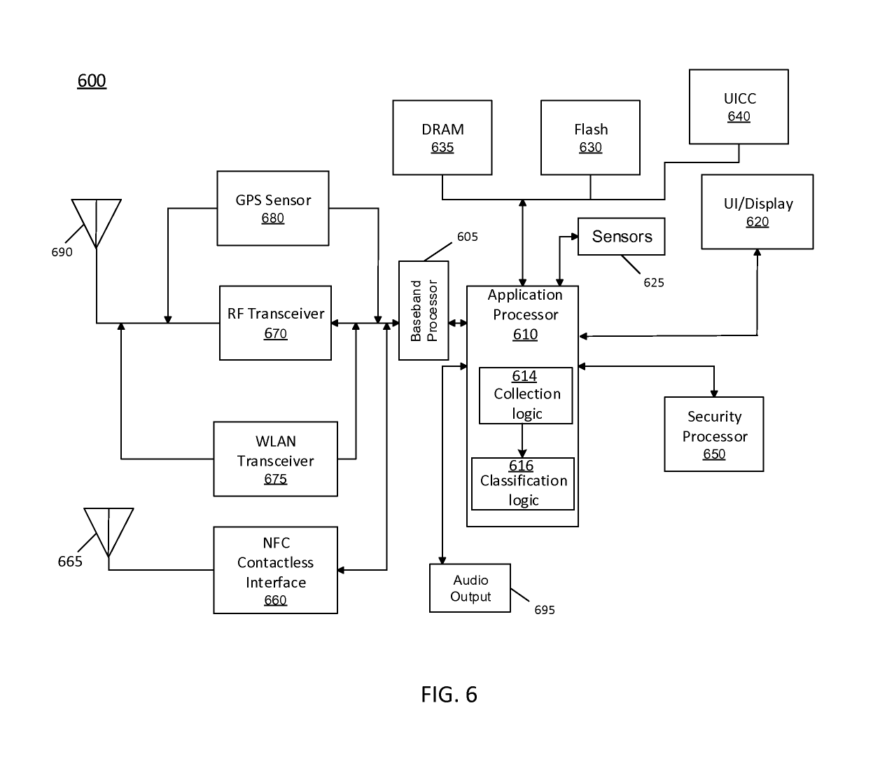

Referring now to FIG. 6, shown is a block diagram of an example system with which embodiments can be used. As seen, system 600 may be a smartphone or other wireless communicator. A baseband processor 605 is configured to perform various signal processing with regard to communication signals to be transmitted from or received by the system. In turn, baseband processor 605 is coupled to an application processor 610, which may be a main CPU of the system to execute an OS and other system software, in addition to user applications such as many well-known social media and multimedia applications. Application processor 610 may further be configured to perform a variety of other computing operations for the device. The application processor 610 may include collection logic 614 to collect a user's browsing history, e.g., URLs visited by the user. The application processor 610 may also include classification logic 616 to classify the browsing history according to high level categories (e.g. the categories suppress identities of the URLs) using models that have been provided, according to embodiments of the present invention. The application processor 610 may provide classification data, e.g., the usage information classified according to category (e.g., suppressing the raw usage data, such as actual URLs and titles, from transmission) to a server, e.g., via RF transceiver 670, according to embodiments of the present invention. The server may store the received usage information. In an embodiment, the usage information can be combined with usage information received from other users, analyzed, and used in analytics that may influence future modification of hardware, software, operating systems, etc. to improve user experience, enhance efficiency in information retrieval, etc.

In turn, the application processor 610 can couple to a user interface/display 620, e.g., a touch screen display. In addition, application processor 610 may couple to a memory system including a non-volatile memory, namely a flash memory 630 and a system memory, namely a dynamic random access memory (DRAM) 635. As further seen, application processor 610 further couples to a capture device 640 such as one or more image capture devices that can record video and/or still images.

Still referring to FIG. 6, a universal integrated circuit card (UICC) 640 comprising a subscriber identity module and possibly a secure storage and cryptoprocessor is also coupled to application processor 610. System 600 may further include a security processor 650 that may couple to application processor 610. A plurality of sensors 625 may couple to application processor 610 to enable input of a variety of sensed information such as accelerometer and other environmental information. An audio output device 695 may provide an interface to output sound, e.g., in the form of voice communications, played or streaming audio data and so forth.

As further illustrated, a near field communication (NFC) contactless interface 660 is provided that communicates in a NFC near field via an NFC antenna 665. While separate antennae are shown in FIG. 6, understand that in some implementations one antenna or a different set of antennae may be provided to enable various wireless functionality.

To enable communications to be transmitted and received, various circuitry may be coupled between baseband processor 605 and an antenna 690. Specifically, a radio frequency (RF) transceiver 670 and a wireless local area network (WLAN) transceiver 675 may be present. In general, RF transceiver 670 may be used to receive and transmit wireless data and calls according to a given wireless communication protocol such as 3G or 4G wireless communication protocol such as in accordance with a code division multiple access (CDMA), global system for mobile communication (GSM), long term evolution (LTE) or other protocol. In addition a GPS sensor 680 may be present. Other wireless communications such as receipt or transmission of radio signals, e.g., AM/FM and other signals may also be provided. In addition, via WLAN transceiver 675, local wireless communications can also be realized.

Additional embodiments are described below.

A first embodiment is a system that includes a processor including at least a first core that includes collection logic to record a history of website accesses of a plurality of websites by a user. The processor also includes classification logic to assign the website accesses to corresponding categories by application of a plurality of models, where each model corresponds to a respective category, and to determine a classification summary that includes a plurality of category metrics, each category metric associated with the respective category, each category metric based on a corresponding measure of the website accesses within the respective category, where the classification summary suppresses a corresponding identity of each website accessed. The system also includes a nonvolatile memory coupled to the processor.

A 2^{nd} embodiment includes elements of the 1^{st} embodiment, where the nonvolatile memory is to store a representation of each of the plurality of models.

A 3^{rd} embodiment includes elements of the 1^{st} embodiment, where each category metric is to include a respective frequency statistic that is based on a count of the website. accesses of the websites assigned to the corresponding category during a determined time period.

A 4^{th} embodiment includes elements of the 1^{st} embodiment. Additionally, each category metric is to include a respective temporal statistic that is based on a cumulative time duration of the website accesses of the websites assigned to the corresponding category during a determined time period.

A 5^{th} embodiment includes elements of the 1^{st} embodiment, where a category count of the categories is less than approximately 100.

A 6^{th} embodiment includes elements of any one of embodiments 1-5, where each category corresponds to a unique set of websites and each website is to be included a single corresponding category.

A 7^{th} embodiment is a method that includes gathering, by a server, website identification data of a plurality of websites and corresponding popularity data; determining by the server an initial set of categories based on the website identification data and the corresponding popularity data; applying a category reduction filter to the initial set of categories to exclude a subset of categories that corresponds to private information of a user that is to access websites via a user system, to produce a reduced set of categories; constructing a final set of categories from the modified set of categories according to a specified count of categories in the final set of categories; building a plurality of models, each model associated with a corresponding category of the final set of categories, each model to provide a quantitative measure of a fit of a particular website for inclusion in the corresponding category; and providing a classification tool to the user system, where the classification tool includes the plurality of models and the final set of categories, where each model is identified with its corresponding category.

An 8^{th} embodiment includes elements of the 7^{th} embodiment, where constructing the final set of categories includes combining two or more categories of the modified set of categories to reduce a count of distinct categories to be included in the final set of categories.

A 9^{th} embodiment includes elements of the 7^{th} embodiment, where building the models includes applying training data to the final set of categories using one or more machine learning techniques.

A 10^{th} embodiment includes elements of the 9^{th} embodiment, where each model is formed based at least in part on universal resource locators (URLs) and corresponding page titles of the training data.

An 11^{th} embodiment includes elements of the 7^{th} embodiment, and further includes periodically updating the classification tool by repeating gathering the website data, determining the initial set of categories, applying the category reduction filter, constructing the final set of categories, and forming the plurality of models.

A 12^{th} embodiment includes elements of the 7^{th} embodiment, where periodically updating the classification tool further comprises periodically updating the category reduction filter.

A 13^{th} embodiment includes elements of the 7^{th} embodiment, where at least some of the categories in the final set of categories pertain to system usage of the user system.

A 14^{th} embodiment includes elements of the 7^{th} embodiment, where the classification tool is to output a classification summary that includes a measure of website accesses for each category of the final set of categories.

A 15^{th} embodiment includes elements of the 14^{th} embodiment, where the classification summary is to suppress an identity of each universal resource locator (URL) of each website represented within a particular category.

A 16^{th} embodiment includes elements of any one of the 7^{th} to the 15^{th} embodiments further includes constructing the category reduction filter based on expert input received from at least one expert source.

A 17^{th} embodiment is a machine readable medium having stored thereon instructions, which if performed by a machine cause the machine to perform a method that includes receiving, by a server from each of a plurality of user systems, a respective classification summary that includes, for each category of a set of categories, a category metric that includes a frequency statistic including a measure of website accesses of websites assigned to the category during a defined time period, where the classification summary is to suppress a corresponding identity of each of the websites assigned to each category; performing an analysis of the classification summary received; and determining modifications of user system design requirements based at least in part on the analysis.

An 18^{th} embodiment includes elements of the 17^{th} embodiment, where at least some of the categories of the set of categories pertain to system usage of each user system from which the classification summaries are received.

A 19^{th} embodiment includes elements of the 17^{th} embodiment, where suppression of the corresponding identity of each of the websites assigned to each category includes prevention of determination of a corresponding universal resource locator (URL) and a corresponding page title of each of the websites reflected in the classification summary.

A 20^{th} embodiment includes elements of any one of the 17^{th} to the 19^{th} embodiments, where each category metric further includes a time duration statistic determined based on a sum of time durations of access, during the defined time period, of each of the websites within the corresponding category.

A 21^{st} embodiment is a method that includes receiving, by a server from each of a plurality of user systems, a respective classification summary that includes, for each category of a set of categories, a category metric that includes a frequency statistic including a measure of website accesses of websites assigned to the category during a defined time period, where the classification summary is to suppress a corresponding identity of each of the websites assigned to each category; performing an analysis of the classification summary received; and determining modifications of user system design requirements based at least in part on the analysis.

A 22^{nd} embodiment includes elements of the 21^{st} embodiment, where at least some of the categories of the set of categories pertain to system usage of each user system from which the classification summaries are received.

A 23^{rd} embodiment includes elements of the 21^{st} embodiment, where suppression of the corresponding identity of each of the websites assigned to each category is to prevent determination of a corresponding universal resource locator (URL) and a corresponding page title of each of the websites reflected in the classification summary.

A 24^{th} embodiment includes elements of any one of the 21^{st} to the 23^{rd} embodiments, where each category metric further includes a time duration statistic determined based on a sum of time durations of access, during the defined time period, of each of the websites within the corresponding category.

A 25^{th} embodiment is a system that includes a server including at least one processor to: receive from each of a plurality of user systems, a respective classification summary that includes, for each category of a set of categories, a category metric that includes a frequency statistic including a measure of website accesses of websites assigned to the category during a defined time period, where the classification summary is to suppress a corresponding identity of each of the websites assigned to each category; perform an analysis of the classification summary received; and recommend modifications of user system design requirements based at least in part on the analysis.

A 26^{th} embodiment includes elements of the 25^{th} embodiment, where at least some of the categories of the set of categories pertain to system usage of each user system from which the classification summaries are received.

A 27^{th} embodiment includes elements of the 25^{th} embodiment, where suppression of the corresponding identity of each of the websites assigned to each category includes to prevent determination of a corresponding universal resource locator (URL) and a corresponding page title of each of the websites reflected in the classification summary.

A 28^{th} embodiment includes elements of any one of embodiments 25-27, where each category metric further includes a time duration statistic determined based on a sum of time durations of access, during the defined time period, of each of the websites within the corresponding category.

A 29^{th} embodiment is a method that includes recording a history of website accesses of a plurality of websites by a user; assigning the website accesses to corresponding categories by application of a plurality of models, where each model corresponds to a respective category; and determining a classification summary that includes a plurality of category metrics, each category metric associated with the respective category, each category metric based on a corresponding measure of the website accesses within the respective category, where the classification summary suppresses a corresponding identity of each website accessed.

A 30^{th} embodiment includes elements of the 29^{th} embodiment, where each category metric is to include a respective frequency statistic that is based on a count of the website accesses of the websites assigned to the corresponding category during a determined time period.

A 31^{st} embodiment includes elements of the 29^{th} embodiment, where each category metric is to include a respective temporal statistic that is based on a cumulative time duration of the website accesses of the websites assigned to the corresponding category during a determined time period.

A 32^{nd} embodiment includes elements of the 29^{th} embodiment, where a category count of the categories is less than approximately 100.

A 33^{rd} embodiment includes elements of any one of embodiments 29-32, where each category corresponds to a unique set of websites and each website is to be included a single corresponding category.

Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A system including:
a processor including at least a first core that includes:
collection logic to record a history of website accesses of a plurality of websites by a user; and
classification logic to assign the website accesses to corresponding categories by application of a plurality of models, wherein each model corresponds to a respective category, and to determine a classification summary that includes a plurality of category metrics, each category metric associated with the respective category, each category metric based on a corresponding measure of the website accesses within the respective category, wherein the classification summary suppresses a corresponding identity of each website accessed; and
a nonvolatile memory coupled to the processor.

2. The system of claim 1, wherein the nonvolatile memory is to store a representation of each of the plurality of models.

3. The system of claim 1, wherein each category metric is to include a respective frequency statistic that is based on a count of the website accesses of the websites assigned to the corresponding category during a determined time period.

4. The system of claim 1, wherein each category metric is to include a respective temporal statistic that is based on a cumulative time duration of the website accesses of the websites assigned to the corresponding category during a determined time period.

5. The system of claim 1, wherein a category count of the categories is less than approximately 100.

6. The system of claim 1, wherein each category corresponds to a unique set of websites and each website is to be included a single corresponding category.

7. A method comprising:
gathering, by a server, website identification data of a plurality of websites and corresponding popularity data;
determining by the server an initial set of categories based on the website identification data and the corresponding popularity data;
applying a category reduction filter to the initial set of categories to exclude a subset of categories that corresponds to private information of a user that is to access websites via a user system, to produce a reduced set of categories;
constructing a final set of categories from the modified set of categories according to a specified count of categories in the final set of categories;
building a plurality of models, each model associated with a corresponding category of the final set of categories, each model to provide a quantitative measure of a fit of a particular website for inclusion in the corresponding category; and
providing a classification tool to the user system, wherein the classification tool includes the plurality of models and the final set of categories, wherein each model is identified with its corresponding category.

8. The method of claim 7, wherein constructing the final set of categories includes combining two or more categories of the modified set of categories to reduce a count of distinct categories to be included in the final set of categories.

9. The method of claim 7, wherein building the models includes applying training data to the final set of categories using one or more machine learning techniques.

10. The method of claim 9, wherein each model is formed based at least in part on universal resource locators (URLs) and corresponding page titles of the training data.

11. The method of claim 7, further comprising periodically updating the classification tool by repeating gathering the website data, determining the initial set of categories, applying the category reduction filter, constructing the final set of categories, and forming the plurality of models.

12. The method of claim 7, wherein periodically updating the classification tool further comprises periodically updating the category reduction filter.

13. The method of claim 7, wherein at least some of the categories in the final set of categories pertain to system usage of the user system.

14. The method of claim 7, wherein the classification tool is to output a classification summary that includes a measure of website accesses for each category of the final set of categories.

15. The method of claim 14, wherein the classification summary is to suppress an identity of each universal resource locator (URL) of each website represented within a particular category.

16. The method of claim 7, further comprising constructing the category reduction filter based on expert input received from at least one expert source.

17. A machine readable medium having stored thereon instructions, which if performed by a machine cause the machine to perform a method comprising:
receiving, by a server from each of a plurality of user systems, a respective classification summary that includes, for each category of a set of categories, a category metric that includes a frequency statistic including a measure of website accesses of websites assigned to the category during a defined time period, wherein the classification summary is to suppress a corresponding identity of each of the websites assigned to each category;
performing an analysis of the classification summary received; and
determining modifications of user system design requirements based at least in part on the analysis.

18. The computer readable medium of claim 17, wherein at least some of the categories of the set of categories pertain to system usage of each user system from which the classification summaries are received.

19. The computer readable medium of claim 17, wherein suppression of the corresponding identity of each of the websites assigned to each category includes preventing determination of a corresponding universal resource locator (URL) and a corresponding page title of each of the websites reflected in the classification summary.

20. The computer readable medium of claim 17, wherein each category metric further includes a time duration statistic determined based on a sum of time durations of access, during the defined time period, of each of the websites within the corresponding category.
